(19) United States
(12) Patent Application Publication
(10) Pub. No.: US 2007/0143664 A1
(43) Pub. Date: Jun. 21, 2007

(54) A COMPRESSED SCHEMA REPRESENTATION OBJECT AND METHOD FOR METADATA PROCESSING

(75) Inventors: Jianjun Fang, Long Grove, IL (US); Bhavan R. Gandhi, Vernon Hills, IL (US); Alfonso Martinez Smith, Algonquin, IL (US); Wei Wang, Hoffman Estates, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/275,276

(22) Filed: Dec. 21, 2005

(51) Int. Cl. G06F 15/00

(52) U.S. Cl. 715/513

(57) ABSTRACT

A compressed binary schema representation object for metadata processing and a related method are provided. The compressed binary schema representation provides savings in bandwidth and processing requirements as compared to textual schema representations. The binary schema representation makes it possible to select and decode only desired schema elements without the need to parse the entire schema.

### FIELD OF THE INVENTION

The invention generally relates to structured data documents and more particularly to representations of metadata schemas.

### BACKGROUND OF THE INVENTION

Structured data documents are used for a wide variety of purposes, including, by way of examples, for databases, for electronic commerce, for graphics, and for multimedia. Some examples of structured data documents include HTML (HyperText Markup Language) documents, XML (eXtensible Markup Language) documents, scalable vector graphics (SVG) files, mp3 audio files, and MPEG-7 multimedia files.

A common feature of structured data documents is the use of schemas to describe the structure, content, and/or semantics of the documents. For example, XML documents may carry just about any kind of data. XML allows the author of a document to define his or her own tags and document structure. An XML schema, on the other hand, defines the legal building blocks of an XML document such as the elements or attributes that can appear in a document, relationships between the elements of a document, the data types of elements and attributes, and default values for elements and attributes. XML schemas are typically written in XML and support data types and namespaces. An XML schema can be reused in other schemas. It is possible to reference multiple XML schemas from a single document.

XML schemas are typically defined in plain text format and thus provide a generally software- and hardware-independent way of communicating data. The use of plain text format, however, typically means that XML documents and their related schema require significant memory and bandwidth for transmission. Additionally, because schema elements are only syntactically organized, the entire schema generally must be parsed before any part of the schema can be used, requiring significant processing time and power on the receiving end.

### BRIEF DESCRIPTION OF THE DRAWINGS

FIG. 1 is a schematic diagram of an embodiment of the invention;

FIG. 2 is a schematic diagram of simple and complex types;

FIG. 3 is a schematic diagram of a binary schema encoding process;

FIG. 4 is a schematic diagram of a configuration of a binary schema format;

FIG. 5 is a schematic diagram of a method for metadata processing and transmitting a schema representation object;

FIG. 6 is a schematic diagram of a method for metadata processing and receiving a schema representation object; and

FIG. 7 is a schematic diagram of an apparatus for metadata processing.

### DETAILED DESCRIPTION

A compressed binary schema representation object for metadata processing and a related method are provided. The object and method provide substantial savings with respect to bandwidth requirements for transmission and processing requirements for decoding a structured data document. These teachings are presented below in the context of an XML (eXtensible Markup Language) document. Those skilled in the art will readily recognize, however, that these teachings are generally applicable to any structured data document.

An advantage of the disclosed binary schema format for metadata processing is the high compression ratio possible relative to textual formats. The binary format described below typically compresses schema size to less than 20% of the original size of the textual format. This high compression ratio significantly reduces network bandwidth requirements during transmission, storage size requirements at the receiving end, and corresponding processing during decoding. These benefits are especially helpful in mobile environments.

The disclosed binary schema format makes use of two generic data structures to implement two fundamental data types commonly used in structured data documents in general, and in XML schemas in particular. A schema is decomposed into a sequence of data structures of complex type and simple type, one after another in a linear fashion.

Another advantage of the disclosed binary schema format is that the basic data structures in the schema can be in an arbitrary sequence. An entry table is provided at the start of the data stream or file to link all of the data structures in the stream or file. The entry table acts at least to some extent like a lookup table that stores the size and offset of each data structure in the stream or file. Inside each complex type data structure, each child element has an index number assigned to it, providing a way to quickly traverse the entire schema tree without performing any searching operation. Additionally, the schema type information is purposely placed at the start of each data structure so that any type matching and verification is facilitated. A decoder using a binary schema object can easily locate the relevant schema fragment and load it into memory prior to using it for selectively decoding a portion of a metadata stream. The same decoder using a textual schema would have to load the entire textual schema and perform full validation and parsing against an incoming instance of the schema.

Another advantage of the disclosed binary schema format is the incorporation of the schema namespace into the binary schema format. This allows a current binary schema table to reference external schema types. A flag consisting of a single bit may be used to indicate whether a schema type is external, in which case the corresponding namespace will follow. The use of this flag eliminates the need to specify the namespace for every internal schema type, thus providing further efficiency.

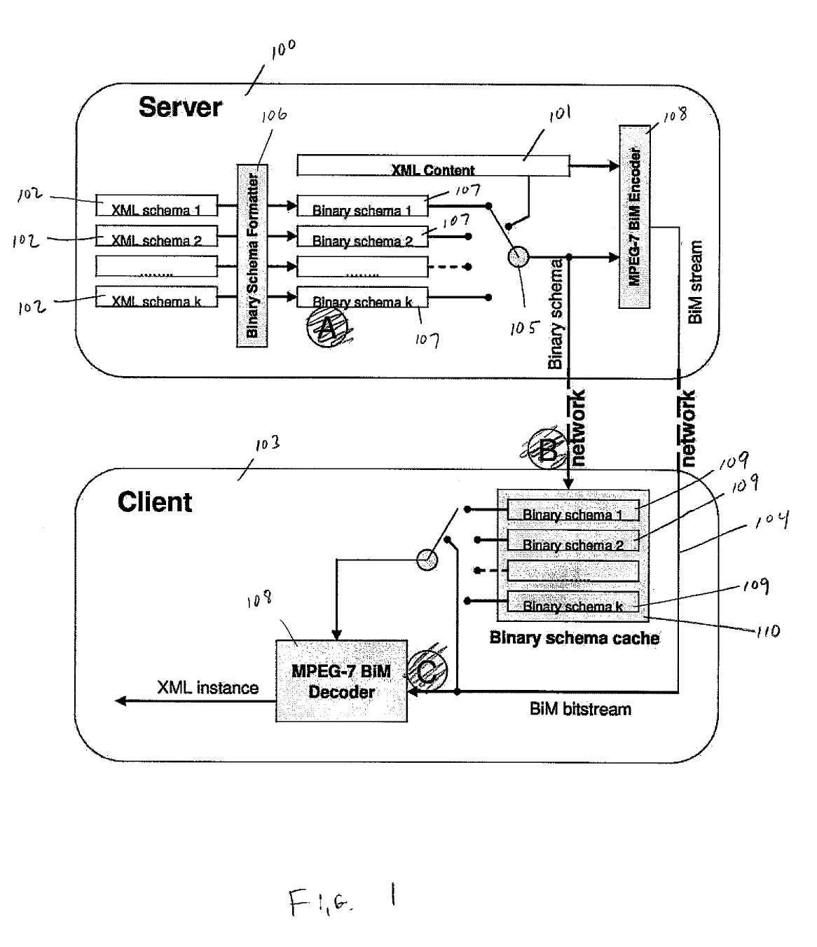

FIG. 1 provides an overview as applied to the example of an XML document, in particular an MPEG-7 multimedia file. A file or data stream is provided at a server 100 and has XML content 101 and one or more XML schema 102 associated with it. Normally, the required textual-based XML schemas would be pushed to the client side 103 before the MPEG-7 encoded binary meta-data (BiM) stream 104 could be decoded. This can consume a significant amount of bandwidth, especially when dynamic schema switching 105 is needed. Furthermore, each XML schema 102 would need to be parsed on the client end 103, which requires additional processing time and processing power.

According to the teachings of this description, the textual-based XML schemas 102 are processed on the server side 100 by a binary schema formatter 106 which converts the XML schemas 102 to binary form 107 prior to transmission. In binary form, all schema elements are linked as a lookup table as described below and compressed individually into an efficient binary structure. An MPEG-7 BiM encoder 108 can use the binary schemas directly and the compressed binary schemas 107 can be efficiently transferred over a network to the client side 103. On the client side 103, an MPEG-7 BiM decoder 108 can dynamically reconfigure itself with the received binary schemas 109 that may be stored in a binary schema cache 110. Because the binary schemas 107 have been pre-processed on the server side 100, they do not require an XML parser on the client side 103, thus saving processing time and power on the client side 103. Those skilled in the art will appreciate that these savings, both in terms of reduced bandwidth requirements for the transmission and processing requirements at the client, make these teachings especially suitable for mobile environments.

Alternatively, the binary schemas 109 could be generated off-line and loaded on the client side 103 for selection by either the server or some automated or semi-automated method. In the case where the schema is selected by a server, the specific binary schema ID can be conveyed by the BiM stream 104.

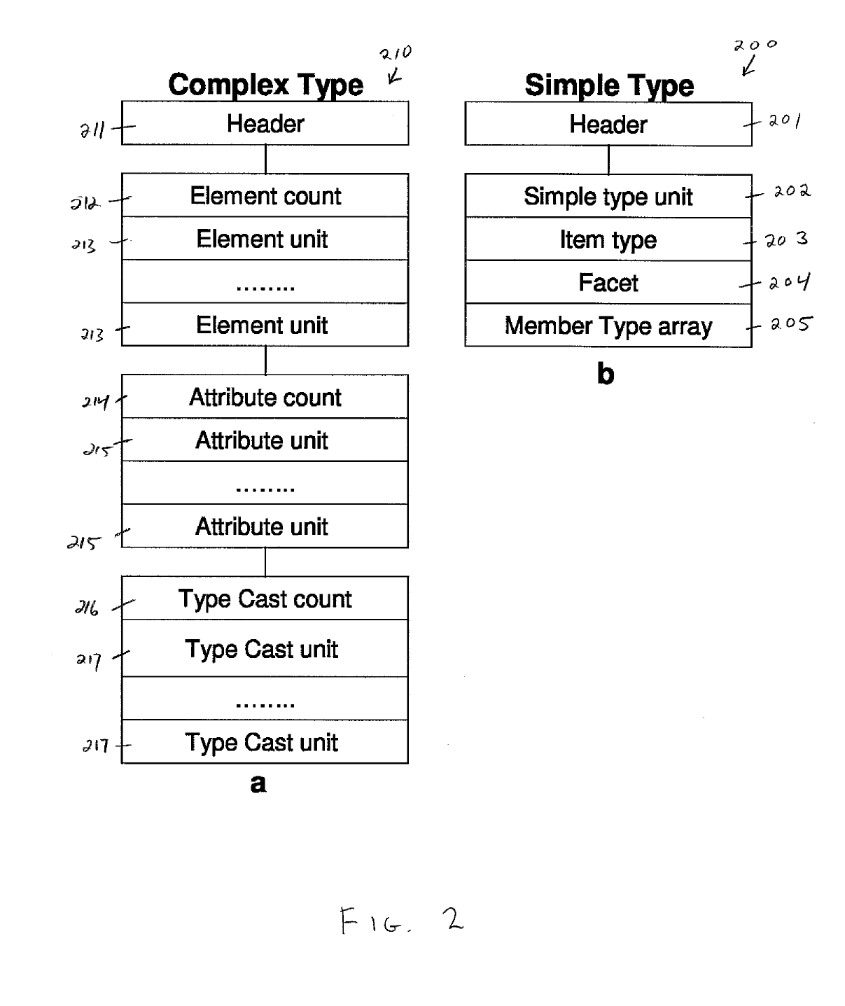

A given XML schema can be decomposed into a sequence comprised of two basic data types, simple types (FIG. 2b) and complex types (FIG. 2a). As shown, a simple type 200 comprises a header 201 and a simple type unit 202. The simple type may be further restricted by its item type 203, by facets 204 associated with the type, and/or by a member type array 205. A complex type 210 comprises a header 211 and may comprise one or more element units 213, attribute units 215, and/or type cast units 217. Each complex type will also typically contain an element count 212, an attribute count 214, and a type cast count 216. Each type may be connected with other types in the schema to form a schema tree. A schema tree consists of one or more roots that provide entry points to the schema.

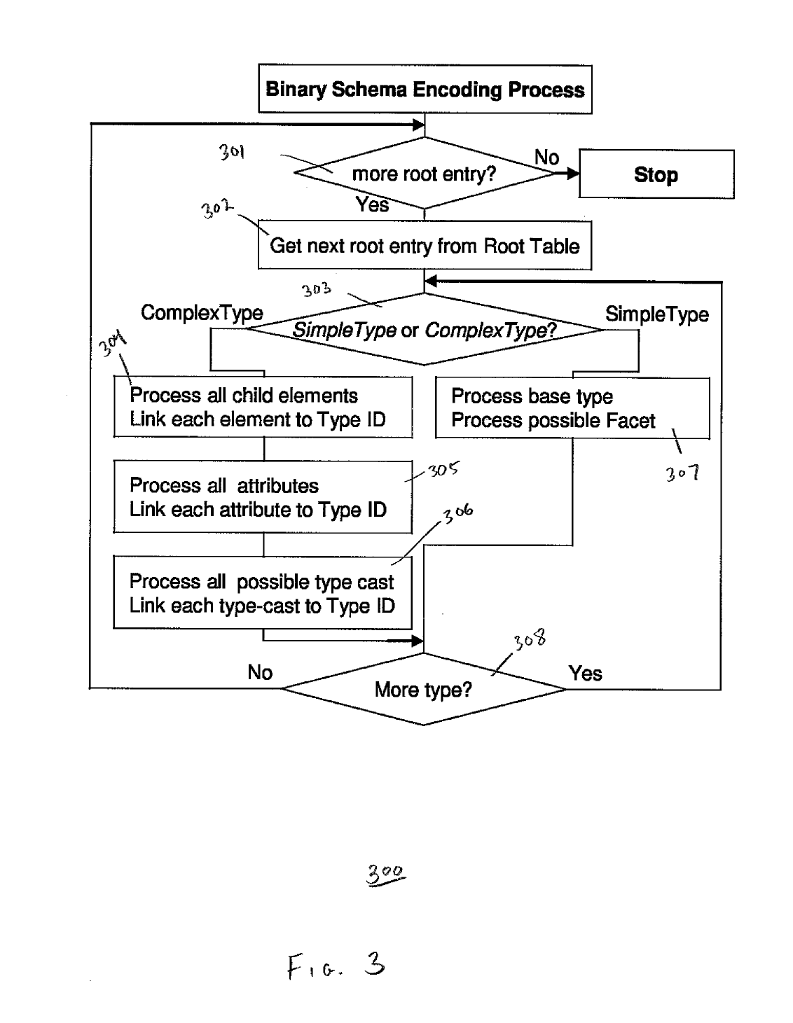

The binary schema encoding process 300 in this illustrative embodiment follows the flow chart of FIG. 3. As long as there are more root entries to process 301, a next root entry from the root table is processed 302. The root entry is examined to determine whether it is a simple or a complex type 303. If it is a complex type, all child elements are processed and linked to the type ID 304, all attributes are processed and linked to the type ID 305, and all possible type casts are processed and linked to the type ID 306. If the root entry is a simple type, the base type and any possible facets are processed 307. If the entry from the root table contains further types, they are examined and processed similarly 308. Otherwise, we return to the top of the flow chart and determine whether there are more root entries to process 301.

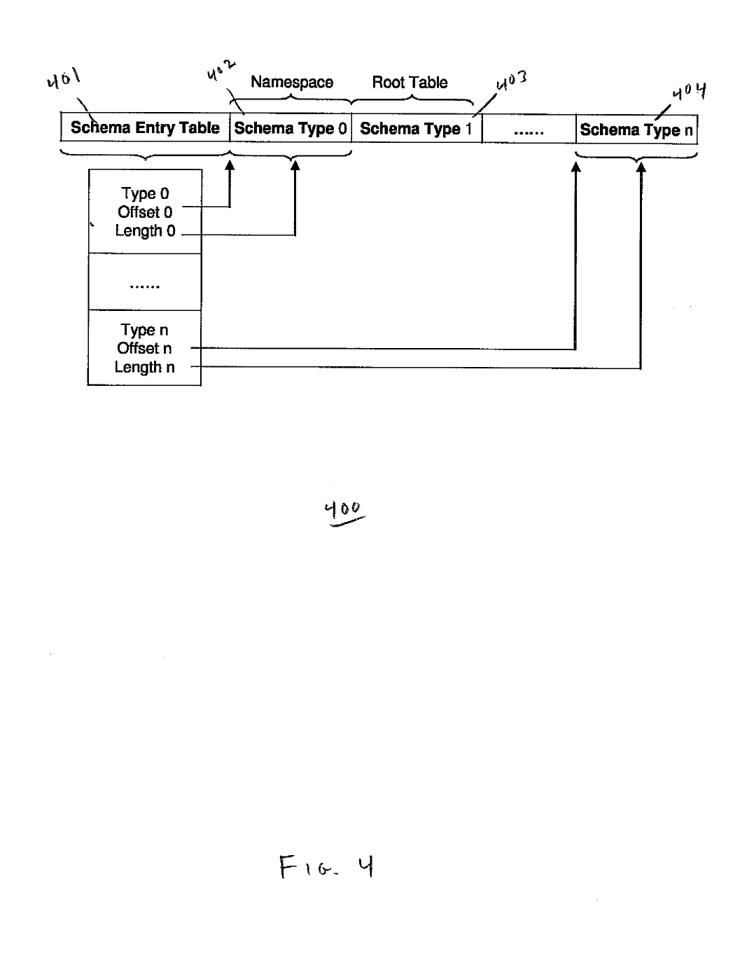

Referring now to FIG. 4, in this illustrative embodiment the configuration of a binary schema format 400 is structured with a schema entry table 401 followed by the namespace 402 for the schema and a sequence of root types 403 defined by the schema. The schema types 404 in the binary schema table are inter-referenced by the schema entry table 401.

As shown in FIG. 4, a schema table consists of entries corresponding to each schema type in the table. Each entry takes a fixed number of bytes, which facilitates fast access based on the index value. The first two entries in the schema entry table 401 have special assignments. Entry 0, the first entry in the table 401, is dedicated to the namespace 402 of the schema table 400. Entry 1 is dedicated to the root table 403. The root table 403 comprises one or more schema types 404. The first four bytes of the schema entry table 401 in this embodiment refer to the size of the schema entry table 401 and an offset to a namespace 402.

The namespace 402 is a special data structure following the schema entry table 401. It specifies the namespace for the binary schema table 400. The namespace may be coded as a character string, whose size and offset are specified in entry 0 of the schema entry table 401.

Even though the schema types are arranged sequentially inside the schema table 400, they are all linked together to form a reversed tree-like structure. At the top of the structure, there are one or more roots. These roots are known as the global entries of the schema table and serve as entry points to the schema table. The root table 403 is the second data structure after the schema entry table 401. An illustrative binary encoding example of a root table 403 is shown in Table 1 below. It starts with the number of root entries in the schema table, followed by the index number of each root entry referencing the entry in the schema entry table. The root table 403 also includes the names of the global elements.

TABLE 1
Binary encoding of a root table

| | |
|---|---|
| number of global entries | vluimsbf8 |
| global entry 0 | vluimsbf8 |
| size of global element 0 | vluimsbf8 |
| global element name 0 | variable |
| . . . | . . . |
| global entry m | vluimsbf8 |
| size of global entry m | vluimsbf8 |
| global element name m | variable |

Note that vluimsbf8 is the designation for a variable length code unsigned integer with its most significant bit first. The size of vluimsbf8 is a multiple of one byte. The first bit of each byte specifies if set to 1 that another byte is present for this vluimsbf8 code word. The unsigned integer is encoded by the concatenation of the seven least significant bits of each byte belonging to this vluimsbf8 code word.

As noted earlier, a complex type element is depicted in FIG. 2a. In this example, the binary encoding of a complex type contains a header 211, an element count 212 and a group of optional child elements 213, an attribute count 214 and a group of optional attributes 215, and a type cast count 216 and a group of optional type casts 217. The binary complex type header includes a string of characters to specify the name of the complex type. In some cases, a complex type also carries inline content that will be contained in the header. If the complex type does not contain inline content, the size of the inline content type will be zero.

An illustrative example for binary encoding of a complex type header is shown in Table 2 below.

TABLE 2
Binary encoding of a complex type header

| | |
|---|---|
| size (in bytes) of type | vluimsbf8 |
| type | variable |
| external flag | 1 bit |
| size (in bytes) of inline content | 7 bits |
| type | |
| inline content type | variable |
| If (external flag = false) { | |

| | |
|---|---|
| primitive type flag | 1 bit |
| entry index | 15 bits |

} else {

| | |
|---|---|
| size (in bytes) of namespace | vluimsbf8 |
| namespace | variable |

}

A complex type child element starts with an element count 212 followed by a sequence of element units 213. An illustrative example of binary encoding of an element unit is depicted in Table 3 below. The values of minOccurs and maxOccurs are encoded using 7 bits each and, thus, can accommodate 0 through 126 occurrences. When all 7 bits of maxOccurs are set to 1, maxOccurs is understood to be “unbounded.”

TABLE 3
Binary encoding of an element unit

| | |
|---|---|
| size (in bytes) of element name | vluimsbf8 |
| element name | variable |
| size (in bytes) of element type | vluimsbf8 |
| element type | variable |
| minOccurs | 7 bits |
| maxOccurs | 7 bits |
| simple element flag | 1 bit |
| external flag | 1 bit |
| if (external flag = false) { | |

| | |
|---|---|
| primitive type flag | 1 bit |
| entry Index | 15 bits |

} else {

| | |
|---|---|
| size (in bytes) of namespace | vluimsbf8 |
| namespace | variable |

}

When the simple-element flag is set, the element carries inline content only. In the case that the inline content is of primitive type, the external flag will be reset and the primitive-type flag will be set.

The location of an element type can be found in the same schema table via the entry index if the external flag is not set or in a different table whose namespace follows if the external flag is set. The use of entry Index allows an application to quickly get the child element type from the same schema table without performing string matching.

An attribute group consists of an attribute count followed by one or more attribute units. An illustrative example of binary encoding for an attribute unit is shown in Table 4 below.

TABLE 4
Binary encoding of an attribute unit

| | |
|---|---|
| size (in bytes) of attribute name | vluimsbf8 |
| attribute name | variable |
| size (in bytes) of attribute type | vluimsbf8 |
| attribute type | variable |
| use flag | 2 bits |
| default flag | 1 bit |
| fixed flag | 1 bit |
| external flag | 1 bit |
| reserved | 3 bits |
| if (external flag = false) { | |

| | |
|---|---|
| primitive type flag | 1 bit |
| entry index | 15 bits |

} else {

| | |
|---|---|
| size (in bytes) of namespace | vluimsbf8 |
| namespace | variable |

}
if (default flag = true {

| | |
|---|---|
| size (in bytes) of default value | vluimsbf8 |
| default value | variable |

}
if (fixed flag = true) {

| | |
|---|---|
| size (in bytes) of fixed value | vluimsbf8 |
| fixed value | variable |

}

Each attribute unit contains three key flags: a use flag, a default flag, and a fixed flag. The use flag is encoded in 2 bits: 0b00 indicates optional; 0b01 indicates required; 0b10 indicates prohibited; and 0b 11 is reserved. The default flag indicates whether a default value will be specified for the attribute. The fixed flag indicates whether a fixed value will be specified for this attribute.

The attribute unit also contains an external flag that indicates the location of the attribute type. If it is external, a namespace will be specified for the external schema. If it is internal, an entry index will be given to locate the corresponding type in the same schema table.

If the attribute is a primitive type, the primitive flag will be set and the name of the type will be specified by the value of attribute type. Because it is assumed that the BiM decoder has knowledge of all primitive types, the schema table in this embodiment need not include any information for the primitive types.

A type cast group consists of a type cast count followed by a group of type cast units. An illustrative example of binary encoding for type cast units is shown in Table 5 below.

TABLE 5
Binary encoding of a type cast unit

| | |
|---|---|
| size (in bytes) of cast type | vluimsbf8 |
| cast type | variable |
| reserved | 7 bits |
| external flag | 1 bit |
| if (external flag = false) { | |

| | |
|---|---|
| reserved | 1 bit |
| entry index | 15 bits |

}

else {

| | |
|---|---|
| size (in bytes) of namespace | vluimsbf8 |
| namespace | variable |

}

Simple types, one of the two basic data types, are depicted in FIG. 2b. As noted earlier, a simple type comprises a header 201 land a single simple type unit 202. The simple type unit 202 may have an item type 203 and may have one or more facets 204. The simple type 202 may further have a member type array 205. An illustrative example of binary encoding for a simple type header is shown in Table 6 below.

TABLE 6
Binary encoding of a simple type header

| | |
|---|---|
| size (in bytes) of type | vluimsbf8 |
| type | variable |
| size (in bytes) of primitive type | vluimsbf8 |
| primitive type | variable |

An illustrative example of binary encoding for a simple type unit is shown in Table 7 below.

TABLE 7
Binary encoding of a simple type unit

| | |
|---|---|
| group type | 2 bits |
| list flag | 1 bit |
| facet flag | 1 bit |
| union flag | 1 bit |
| reserved | 3 bits |
| if (list flag = true) { | |

| | |
|---|---|
| size (in bytes) of item type | vluimsbf8 |
| item type | variable |

}
if (facet flag = true) {

| | |
|---|---|
| facet | variable |

}
if (union flag = true) {

| | |
|---|---|
| member type array | variable |

}

By one approach, a simple type belongs to one of three categories, known as group types. In this illustrative example a group type is encoded in 2 bits: 0b00 indicates atomic; 0b01 indicates union; 0b10 indicates list; and 0b11 is reserved. The facet flag indicates whether a facet is specified for the simple type. The union flag indicates whether a member type array is specified for the simple type. The list flag indicates whether an item type is specified for the simple type.

A string array carries an array of character strings. An illustrative example of binary encoding for a string array is shown in Table 8 below. A string array can be used for a member type array in a simple type unit, or for an enumeration array in a facet.

TABLE 8
Binary encoding of a string array

| | |
|---|---|
| array count | vluimsbf8 |
| size (in bytes) of string | vluimsbf8 |
| string | variable |
| . . . | . . . |
| size (in bytes) of string | vluimsbf8 |
| string | variable |

A facet 204 may be used to specify restrictions for a simple type unit 202. An illustrative example of binary encoding for a facet 204 is shown in Table 9 below. In this example the value of white space is encoded in 2 bits: 0b00 indicates preserve; 0b01 indicates replace; 0b10 indicates collapse; and 0b11 is reserved.

TABLE 9
Binary encoding of a facet

| | |
|---|---|
| size (in bytes) of facet | vluimsbf8 |
| white space | 2 bits |
| pattern flag | 1 bit |
| enumeration flag | 1 bit |
| reserved | 4 bits |
| length flag | 1 bit |
| min length flag | 1 bit |
| max length flag | 1 bit |
| min inclusive flag | 1 bit |
| max inclusive flag | 1 bit |
| min exclusive flag | 1 bit |
| max exclusive flag | 1 bit |
| reserved | 1 bit |
| if (pattern flag = true) { | |

| | |
|---|---|
| size (in bytes) of pattern | vluimsbf8 |
| pattern | variable |

}
if (enumeration flag = true) {

| | |
|---|---|
| enumeration array | variable |

}
if (length flag = true) {

| | |
|---|---|
| length | 8 bits |

}
if (min length flag = true) {

| | |
|---|---|
| min length | 8 bits |

}
if (max length flag = true) {

| | |
|---|---|
| max length | 8 bits |

}
if (min inclusive flag = true) {

| | |
|---|---|
| min inclusive | 32 bits |

}
if (max inclusive flag = true) {

| | |
|---|---|
| max inclusive | 32 bits |

}
if (min exclusive flag = true) {

| | |
|---|---|
| min exclusive | 32 bits |

}
if (max exclusive flag = true) {

| | |
|---|---|
| max exclusive | 32 bits |

}

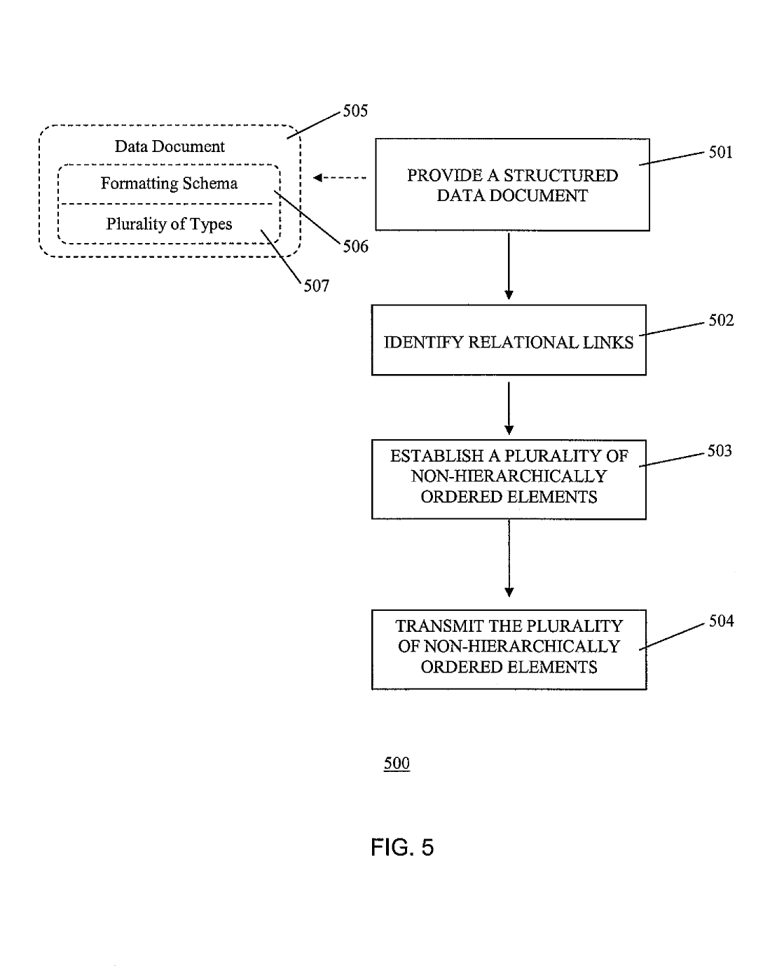

An illustrative method of using a compressed schema representation object such as the one described herein is depicted in FIG. 5. By this illustrative approach a structured data document 505 is provided 501. The structured data document 505 comprises a formatting schema 506 having one or more types 507. Relational links between specific types are identified 502. A plurality of substantially non-hierarchically ordered elements is established 503 wherein at least some of the elements comprise specific types and their corresponding relational links. The plurality of substantially non-hierarchically ordered elements is then transmitted 504.

One example of a kind of structured data document that might be thus provided is an XML document. The types 507 could then comprise complex types and simple types as described above. Further, the relational links could define a hierarchical relationship for the plurality of types.

It can be desirable in some circumstances, for example in mobile environments, to compress the non-hierarchically ordered elements before transmission. The reduction in size resulting from compression provides efficiencies in bandwidth usage and in processing time by the receiver. Further efficiencies can be achieved if at least some of the elements are individually compressed, thus enabling individual selection and decompression of the elements.

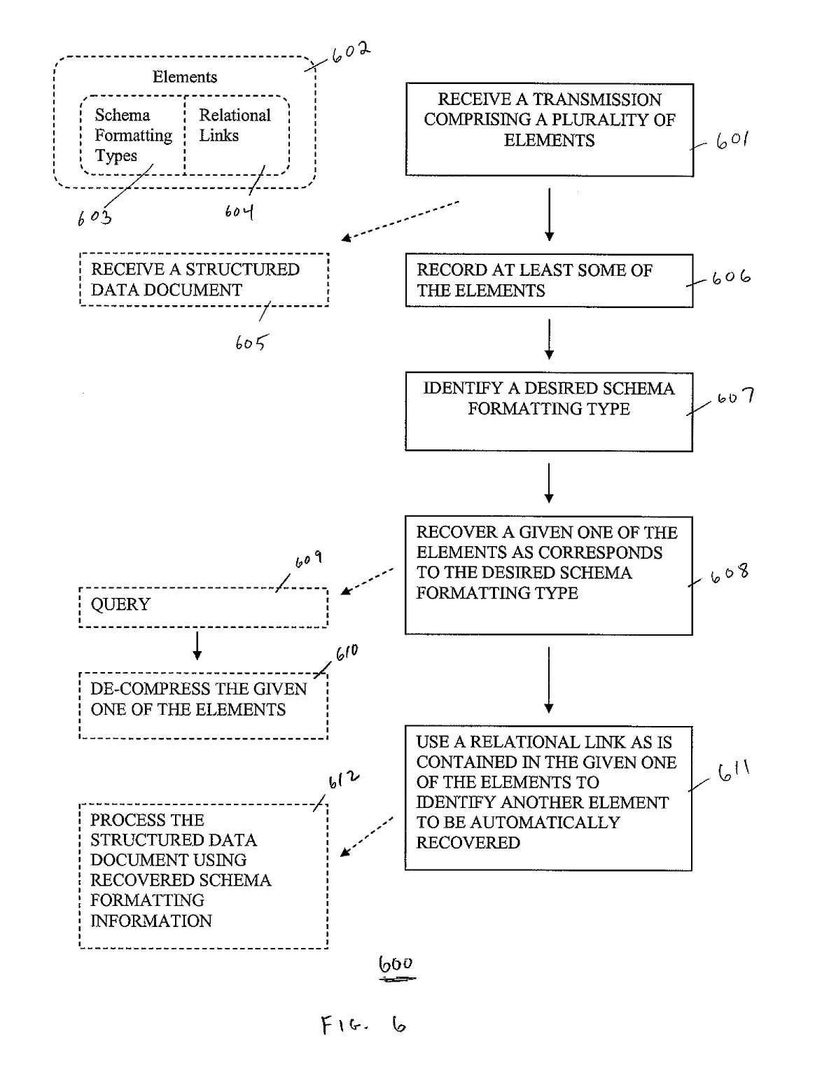

An illustrative example of a method 600 of using a schema object, such as the one described herein, for receiving information is depicted in FIG. 6. One or more transmissions, comprising one or more pluralities of substantially non-hierarchically ordered elements 602, at least some of which comprise schema formatting type 603 and corresponding relational links 604, is received 601. A structured data document may optionally also be received 605.

A record of at least some of the received elements is made 606 at the receiving end. A desired schema formatting type is identified 607, and elements as correspond to the desired schema formatting type are recovered 608. If the elements are in a compressed format, the recovery process 608 may comprise querying the schema 609 and decompressing the desired schema formatting type 610. The desired schema formatting type can optionally be decompressed separately from others of the received elements.

A relational link corresponding to the recovered element may be used to identify at least another one of the elements to be automatically recovered 611. If a structured data document was received 605, it may be processed 612 using schema formatting information recovered 608.

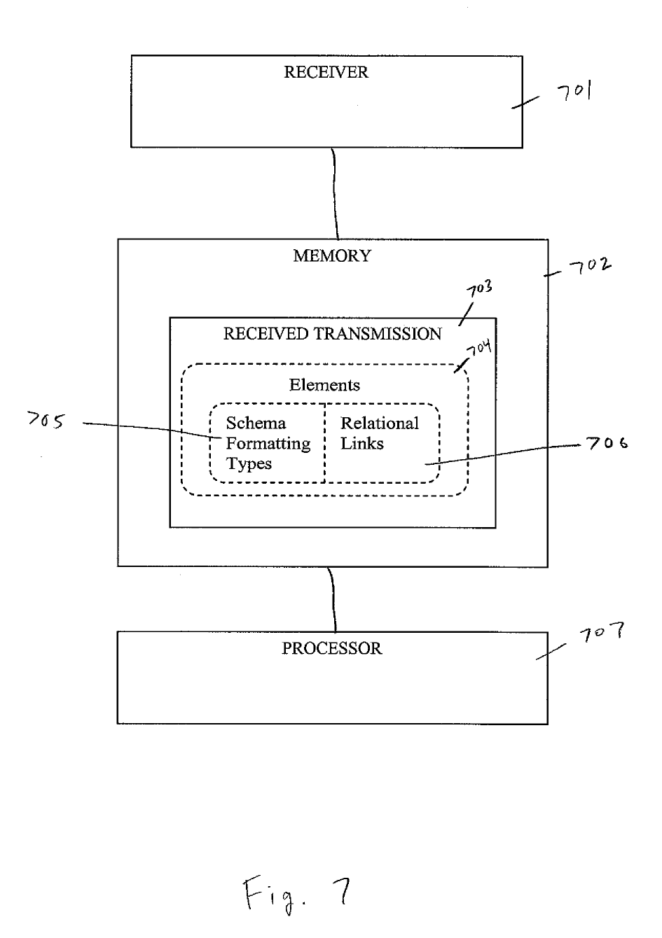

An illustrative example of an apparatus for receiving and processing a schema representation object is depicted in FIG. 7. A receiver 701 is operably coupled to a memory 702. The memory 702 stores at least one received transmission 703 comprising a plurality of substantially non-hierarchically ordered elements 704. At least some of the elements 704 comprise selected schema formatting types 705 and corresponding relational links 706.

A processor 707 is operably coupled to the memory 702. The processor is configured and arranged to: identify a desired schema formatting type 705; recover a given one of the plurality of substantially non-hierarchically order elements 704 as corresponds to the desired schema formatting type 705; and use at least one relational link 706 to identify at least one other one of the plurality of substantially non-hierarchically ordered elements 704 to be automatically recovered.

The teachings herein provide several technical benefits in the field of metadata processing. A binary schema object will generally be more efficient than its textual counterpart. Even in situations where the sizes of the textual and binary schemas may be comparable, a binary schema object should outperform it textual counterpart in operation. A decoder using a binary schema object can search the relevant schema fragment and load it into memory prior to using it for selectively decoding a portion of a metadata bit stream. The same decoder, using a textual schema, would have to load the entire textual schema and perform a full validation and parsing against an incoming instance of the schema, consuming considerably more time, memory, and processing power than the equivalent binary schema.

An important benefit derived from the teachings herein is compatibility between binary metadata schema objects used in binary metadata decoding. The binary metadata object is a binary format that is independent of the client's software. Therefore, it can be understood by any client capable of reading the format. In terms of schema compatibility, if a device finds itself operating in the presence of more than one schema, it can simply switch to a different binary metadata schema object from several of these available, possible in memory, secondary storage, or received from a remote server during decoder set up. The binary metadata schema object can also guarantee compatibility between data models in a content management system, since the schema database can be dynamically configured to match the schema being used.

The benefits of the teachings herein are especially important in mobile communications scenarios. Since binary metadata decoding relies heavily on schema information, defining an efficient binary schema format that directly serves the requirements of a binary metadata decoder removes the most important bottleneck toward efficient operation.

The foregoing relates to exemplary embodiments of the invention. It is understood that other embodiments and variants are possible which lie within the spirit and scope of the invention as set forth in the following claims.

1. A method comprising:
providing a structured data document having a corresponding formatting schema, wherein the formatting schema is comprised of a plurality of types;
identifying relational links between specific ones of the plurality of types; - establish a plurality of substantially non-hierarchically ordered elements, wherein at least some of the elements comprise selected types and relational links as correspond to the selected types;
transmitting the plurality of substantially non-hierarchically ordered elements.

2. The method of claim 1 wherein the structured data document comprises an Extensible Markup Language (XML) data document.

3. The method of claim 1 wherein the plurality of types comprise complex types and simple types.

4. The method of claim 1 wherein the relational links define a hierarchical relationship for the plurality of types.

5. The method of claim 1 wherein transmitting the plurality of substantially non-hierarchically ordered elements further comprises:
compressing the plurality of substantially non-hierarchically ordered elements to provide compressed ordered elements;
transmitting the compressed ordered elements.

6. The method of claim 5 wherein compressing the plurality of substantially non-hierarchically ordered elements to provide compressed ordered elements further comprises individually compressing at least some of the plurality of substantially non-hierarchically ordered elements.

7. A method comprising:
receiving at least one transmission comprising a plurality of substantially non-hierarchically ordered elements wherein at least some of the elements comprise selected schema formatting types and relational links as correspond to the selected schema formatting types;
recording at least some of the plurality of substantially non-hierarchically ordered elements;
identifying a desired schema formatting type;
recovering a given one of the plurality of substantially non-hierarchically ordered elements as corresponds to the desired schema formatting type;
using at least one relational link as is contained in the given one of the plurality of substantially non-hierarchically ordered elements to identify at least one other one of the plurality of substantially non-hierarchically ordered elements to be automatically recovered.

8. The method of claim 7 wherein the plurality of substantially non-hierarchically ordered elements are organized into more than one plurality of substantially non-hierarchically ordered elements; and
identifying a desired schema formatting type further comprises identifying one plurality of substantially non-hierarchically ordered elements.

9. The method of claim 7 wherein receiving a transmission further comprises receiving a structured data document and wherein the method further comprises:
processing the structured data document using schema formatting information as is recovered using the plurality of substantially non-hierarchically ordered elements.

10. The method of claim 7 wherein recovering a given one of the plurality of substantially non-hierarchically ordered elements further comprises:
querying; and
de-compressing the given one of the plurality of substantially non-hierarchically ordered elements.

11. The method of claim 10 wherein de-compressing the given one of the plurality of substantially non-hierarchically ordered elements further comprises individually de-compressing the given one of the plurality of substantially non-hierachically elements separate from at least others of the plurality of substantially non-hierarchically ordered elements.

12. The method of claim 7 wherein the desired schema formatting type comprises an Extensible Markup Language (XML) schema formatting type.

13. The method of claim 7 wherein the desired schema formatting type may comprise either of a complex type and a simple type.

14. The method of claim 7 wherein the at least one relational link defines, in part, a hierarchical relationship with respect to schema formatting types.

15. An apparatus comprising:
a receiver;
a memory operably coupled to the receiver and having at least one received transmission stored therein, wherein the at least one received transmission comprises a plurality of substantially non-hierarchically ordered elements wherein at least some of the elements comprise selected schema formatting types and relational links as correspond to the selected schema formatting types;
a processor operably coupled to the memory and being configured and arranged to:
identify a desired schema formatting type;
recover a given one of the plurality of substantially non-hierarchically ordered elements as corresponds to the desired schema formatting type;
use at least one relational link as is contained in the given one of the plurality of substantially non-hierarchically ordered elements to identify at least one other one of the plurality of substantially non-hierarchically ordered elements to be automatically recovered.

16. The apparatus of claim 15 wherein the transmission further comprises a structured data document and wherein the processor is further configured and arranged to process the structured data document using schema formatting information as is recovered using the plurality of substantially non-hierarchically ordered elements.

17. The apparatus of claim 15 wherein the processor is further configured and arranged to de-compress the given one of the plurality of substantially non-hierarchically ordered elements.

18. The apparatus of claim 15 wherein the processor further comprises means for:
identifying the desired schema formatting type;
recovering the given one of the plurality of substantially non-hierarchically ordered elements as corresponds to the desired schema formatting type;
using the at least one relational link as is contained in the given one of the plurality of substantially non-hierarchically ordered elements to identify at least one other one of the plurality of substantially non-hierarchically ordered elements to be automatically recovered.

19. The apparatus of claim 15 wherein the processor further comprises means for:
querying; and
individually de-compressing the given one of the plurality of substantially non-hierarchically ordered elements separate from at least others of the plurality of substantially non-hierarchically ordered elements.
